(19) United States
(12) Patent Application Publication
(10) Pub. No.: US 2009/0265420 A1
(43) Pub. Date: Oct. 22, 2009

(54) METHOD OF RENDERING AT LEAST ONE ELEMENT IN A CLIENT BROWSER

(75) Inventors: Esben Krag Hansen, Birkerød (DK); Martin Lindboe, Copenhagen S (DK); Thomas Ambus, Copenhagen N (DK); Anne-Sofie Nielsen, Hørsholm (DK); Jens Sorensen, Hørsholm (DK); Tobias Tobiasen, Olstykke (DK)

Correspondence Address: CANTOR COLBURN, LLP, 20 Church Street, 22nd Floor, Hartford, CT, 06103, US

(73) Assignee: KAPOW TECHNOLOGIES R & D A/S, Hørsholm (DK)

(21) Appl. No.: 12/301,075

(22) PCT Filed: May 15, 2006
(86) PCT No.: PCT/DK06/00262

§ 371 Date: Feb. 17, 2009

(51) Int. Cl. G06F 15/16

(52) U.S. Cl. 709/203

(57) ABSTRACT

“The invention relates to a method of rendering at least one element E in a client browser CB at a client CL, where the element E is defined at an intermediate web server IWS by element representative data ERD and where the element is obtained from at least one data source DS, the method including the steps of performing an analytical rendering AR having a transformation of the element representative data ERD into analytically expressed element defining data AEEDD including unknown quantities UQ, performing a visual rendering where the unknown quantities UQ are substituted with client specific factors CSF. Thus, the invention benefits from several advantages individually or in combination, such as: a rendering of an element may be performed at the intermediate server in spite of the fact that the positioning of other elements or client specific factors are generally unknown at the time of performing the intermediate rendering, a rendering of one element to a client may in fact be shared by several different clients although the client specific factors are different due to the fact that these are analytically rendered and, an analytical rendering at the intermediate server may in fact facilitate a very flexible rendering at the clients, thereby enabling that the client specific factors may be different.”

### FIELD OF THE INVENTION

The invention relates to the field of data communication. More particularly the invention concerns with a method of rendering at least one element in a client browser according to claim 1.

### BACKGROUND OF THE INVENTION

The World Wide Web offers several different opportunities to the world community in relation to business transactions, sharing of information, communication, etc.

A problem in the known art of Internet surfing is that only a small part of a web site may be of interest to a user. Furthermore a widely known fact is that the structure of web content is very heterogeneous and non-uniform.

Therefore it is a fact that several problems may occur when parts of content in a web document is drawn out of its context. These problems may be regarding business logic, computation of business logic, visual positioning and presentation of the content.

### SUMMARY OF THE INVENTION

The invention relates to a Method of rendering at least one element in a client browser at a client,

wherein said element is defined at an intermediate web server by element representative data and where said element is obtained from at least one data source,
said method comprising the steps of
performing an analytical rendering comprising a transformation of element representative data into analytically expressed element defining data comprising unknown quantities,
performing a visual rendering wherein said unknown quantities are substituted with client specific factors.

According to an embodiment of the invention it is possible to represent a given element in a rendering at least partly by means of an analytical expression instead of a complete numerical rendering thereby ensuring that unknown quantities may be represented correct at the client but also to obtain an efficient rendering in the sense that the analytical expressions may relate to individual client specific factors which may be generally represented. Thus, a relative analytical expression may be sent to several different clients having different client specific factors, e.g. different settings as one single expression which comprehensively defines some or all intended renderings at the different clients as the analytical expressions may be converted to different final visual renderings at the clients according to the local client specific factors.

The transformation of the content in the element representative data includes a generation of analytically expressed element defining data.

According to the invention, the intermediate web server is located between the data source and the clients, but alternately the data source may be integrated at the data source.

It is noted that the analytically expressed element defining data may be transmitted to the clients on conventional manner, e.g. coded in DHTML, as long as the analytical expressions are converted into tangible visual renderings by substitution of some or preferably all, unknown quantities at the clients.

Thus, the invention benefits from several advantages individually or in combination, such as:

a rendering of an element may be performed at the intermediate server in spite of the fact that the positioning of other elements or client specific factors are generally unknown at the time of performing the intermediate rendering,
a rendering of one element to a client may in fact be shared by several different clients although the client specific factors are different due to the fact that these are analytically rendered and
an analytical rendering at the intermediate server may in fact facilitate a very flexible rendering at the clients, thereby enabling that the client specific factors may be different.

Evidently, several other benefits of the invention apply.

The client specific factors may be any client specific setting, state or representation required to perform the final rendering of an element at the client. Such factor may e.g. be any positioning properties, e.g. .left .offsetTop, .offsetLeft, .scrollTop etc. The expression “element” refers to an element occurring in the present document to be rendered. It is noted that an element may be affected both by unknown quantities referring to the element itself, other elements or unknown quantities related to client settings such as screen data of the client.

In practice, the analytical rendering performed at the intermediate server avails the possibility of performing a rendering which may be regarded as analytically complete in spite of the fact that the performed rendering comprises unknown quantities. One of the important aspects of the invention is that these quantities are pre-recognized as unknown and that the visual rendering at the intermediate server is in fact able to establish analytical expressions due to the fact that the unknown quantities forms part of the rendering algorithms performed at the intermediate server. A further important aspect is of course that the analytical rendering relies on the fact that unknown quantities may be substituted by client specific factors representing different settings of the client or relevant content of the document object model (DOM) of the client.

It should be noted that the intermediate server may communicate with other data sources in the form of data bases or web-servers again communicating with data sources or the intermediate server may comprise all relevant data sources “on board”.

According to a preferred embodiment of the invention, the data sources comprises one or several web-based web sites and the intermediate web server comprises a web-clipping server where web-clippings are extracted and combined into relevant web-clippings or combinations of web-clipping and passed on customized to specified clients, if necessary by means of analytical expressions.

Furthermore, the invention relates to a method of rendering at least one element in a client browser at a client according to claim 1,

wherein said element is defined at an intermediate web server by element representative data and where said element is obtained from at least one data source,
said method comprising the steps of
performing an analytical rendering comprising a transformation of said element representative data into analytically expressed element defining data comprising unknown quantities,
transmitting said analytically expressed element defining data to the client browser,
performing a visual rendering on the basis of said analytically expressed element defining data wherein said unknown quantities are substituted with client specific factors obtainable in the present context.

According to an advantageous embodiment of the invention the analytically expressed element defining data are transmitted to the client enabling a final visual rendering by substitution with client specific factors available at the client.

In an embodiment of the invention, said element is defined in a Document Object Model.

In an embodiment of the invention, said element is defined in a Document Object Model by means of a node.

In an embodiment of the invention, said element is defined by an object and corresponding properties in a Document Object Model.

In an embodiment of the invention, said analytical rendering is performed on said intermediate web server.

In an embodiment of the invention, said analytical rendering is performed at the client.

In an embodiment of the invention, said analytical rendering comprises a transformation of existing positioning values into relative positioning values with respect to a Document Object Model.

In an embodiment of the invention, said analytical rendering comprises a transformation of existing positioning values into relative positioning values with respect to a Document Object Model of the client.

According to the invention, the analytical rendering performed by the analytical rendering unit may comprise process of partially evaluating a script with the goal of evaluating as many expressions as possible not related to positioning, and building a set of remaining positioning expressions. The remaining positioning expressions cannot be further evaluating without obtaining certain unknown quantities which are only known at the client.

In an embodiment of the invention, said client specific factors are continuously transmitted from said client to said intermediate web server to be incorporated in said analytical rendering.

Thus, the analytically rendering at the intermediate web server may be based on client specific factors which on a runtime basis or a need-to-know basis is transmitted from the client to facilitate a complete and final rendering at the intermediate server by eliminating unknown quantities at least partly.

In an embodiment of the invention, said analytically expressed element representing data comprises data coded in at least one markup language.

According to an embodiment of the invention at least one markup language comprises e.g. HTML, XHTML, XML or WML, etc including scripting languages and Cascading Style Sheets (CSS).

In an embodiment of the invention, said analytically expressed element representing data comprises data coded in a markup language.

In an embodiment of the invention, said analytically expressed element representing data comprises data coded in HTML, XHTML, XML or WML, etc.

In an embodiment of the invention, said analytically expressed element representing data comprises definitions in scripting languages, e.g. JavaScript, Jscript, Flash, VBScript etc.

In an embodiment of the invention, said unknown quantities comprises content of the document object model of the client.

In an embodiment of the invention, said unknown quantities is defined by properties with reference to a document object model.

In an embodiment of the invention, said unknown quantities comprises content of the document object model of the client.

In an embodiment of the invention, said unknown quantities comprises information of how to modify a document object model.

In an embodiment of the invention, said unknown quantities comprises information of how to modify a document object model in a client browser.

It is noted that unknown quantities may in practice advantageously comprise element specific data of a client. Thus, when the analytical rendering involves a relative positioning of e.g. a second table with respect to another first table, the positioning information must be present in order to make a final visual rendering of the second table at the client. The following example is non-limiting and only stated in order to highlight the potential of the invention. In order to facilitate such rendering according to an embodiment of the invention, the second table may simply be rendered analytically e.g. as a pre-final rendering comprising all available final values together with an expression, e.g. E, representing the calculation of a pixel value using quantities unavailable at the intermediate server, which defines the position relative to the first table. The analytical expression may then be passed to the client, where the unknown quantities are replaced with a number, a client factor obtained from the client, and E is evaluated to yield a pixel value of e.g. 8 pixels E=8 relative to the first table.

In other words, the unknown quantities may both represent concrete values and numbers or implicit relative information enabling those elements to be positioned relative to other previously rendered elements or relative to a desired window of the client computer. The relative position of an element may be resolved in several different ways within the scope of the invention e.g. as a relative positioning to another specified element or e.g. simply be letting the analytical rendering position all elements relative to an unknown reference which is only known at the client as a client specific factor.

In an embodiment of the invention, said unknown quantities comprises definitions of sizes and positions, e.g. position of existing elements at a client, font types, font sizes, browser types, window sizes, screen size, screen resolution etc.

In an embodiment of the invention, said unknown quantities comprises definitions of sizes and positions, e.g. position of existing elements at a client, font types, font sizes, browser types, window sizes, screen size, screen resolution etc. defined as corresponding exact values at said client.

According to an embodiment of the invention said unknown quantities are contained by the client or by the client browser. Said unknown quantities may in an embodiment of the invention comprise factors that are exclusively accessible in the context wherein they are visually rendered, i.e. at the client.

In an embodiment of the invention, said unknown quantities comprises position properties with reference to a Document Object Model.

In an embodiment of the invention, said unknown quantities comprises position properties with reference to a Document Object Model comprising “element.X”

According to an embodiment of the invention said position properties comprising “element.X”, the X may be any positioning properties, e.g. .left .offsetTop, .offsetLeft, .scrollTop etc. The expression “element” refers to an element occurring in the present document to be rendered.

In an embodiment of the invention, said unknown quantities comprises position properties with reference to a Document Object Model comprising “<element>.left”, “<element>.offsetTop”, “<element>.offsetLeft”, or “<element>.scrollTop” etc.

In an embodiment of the invention, said unknown quantities are coded as unknown quantities representing numbers.

In an embodiment of the invention, said unknown quantities representing numbers are transmitted to the client browser to be decoded by means of said client specific factors.

In an embodiment of the invention, said client specific factors comprises factors depending on the client settings.

In an embodiment of the invention, said client specific factors comprises factors dependent on the positioning of other elements at the client.

Positioning of other elements at the client may e.g. relate to visual positioning of an element at the display of a client computer.

In an embodiment of the invention, said client specific factors represents factual or relative data to substitute said unknown quantities.

In an embodiment of the invention, said intermediate web server comprises a computer communicating with said client over the internet protocol (IP).

In an embodiment of the invention, said intermediate web server comprises a computer transmitting analytically expressed element defining data via the internet protocol to a client.

In an embodiment of the invention, said intermediate web server comprises a web clipping server.

According to an embodiment of the invention, a web clipping server is a server establishing a clip instance on the basis of said an intermediate rendering. A clip instance may be a part of an existing web site or web page defined on the internet.

In an embodiment of the invention, said intermediate web server comprises a computer communicating with said at least one data source over the internet protocol.

In an embodiment of the invention, said client browser comprises an application that provides a way to look at and interact with all data, e.g. data retrieved from the World Wide Web.

In an embodiment of the invention, said client browser CB comprises a Document Object Model (DOM) e.g. a W3C DOM.

In an embodiment of the invention, said client is a device comprising a central processing unit (CPU) and a display.

A client in the present context designates a client which is able to communicate with a web server, e.g. the intermediate web server via a communication network, e.g. the Internet.

In an embodiment of the invention, said client is a device communicating with said intermediate web server via a network, e.g. public data communication network.

In an embodiment of the invention, said client is a device communicating with said intermediate web server via the Internet Protocol via port 80 or 443.

According to an embodiment of the invention, it is advantageous for the client to communicate with the web server through the Internet Protocol via port 80 or 443 because these ports typically are opened for communicating with a public data communication network without being blocked by a firewall.

In an embodiment of the invention, said at least one data source comprises a web document located at a website.

In an embodiment of the invention, said at least one data source comprises a database.

It is generally noted that the data source may be located at any suitable data carrier such as magnetic, optical and electronic or any combination. The data source may also communicate with the intermediate server by any suitable communication channels such as web-based communication, dedicated data tunnels, LAN network and the channels may be wireless or wired.

In an embodiment of the invention, said at least one data source DS comprises at least two data sources

According to an embodiment of the invention said method is advantageous in connection with the web clipping technology and with the integration technology, The clipping instance is to be displayed correctly in the client browser, and is thus dependent of said analytically expressed rendering process.

Moreover the invention relates to a rendering intermediate web server for rendering at least one element wherein said element is defined at the intermediate web server by analytically expressed element representative data and wherein said element is obtained from a data source,

said rendering server comprising
an analytically rendering unit, performing an analytical rendering involving a transformation of the content in said element representative data into analytically expressed element representative data comprising analytically expressed unknown quantities,
and a rendering transmitter, transmitting said transformed element representative data to a client.

In an embodiment of the invention, said client comprises a client browser.

Moreover the invention relates to use of an analytically rendering for representation of a visual element retrieved from a data source for establishment of a visual rendering at a client.

### THE DRAWINGS

The invention will now be described with reference to the drawings of which

FIG. 1 illustrates one embodiment of the invention,

FIG. 2 illustrates a more detailed description an embodiment of the present invention,

FIG. 3 illustrates a further embodiment of the invention,

FIG. 4 illustrates a further embodiment of the invention and

FIG. 5 illustrates an alternative embodiment of the invention.

### DETAILED DESCRIPTION

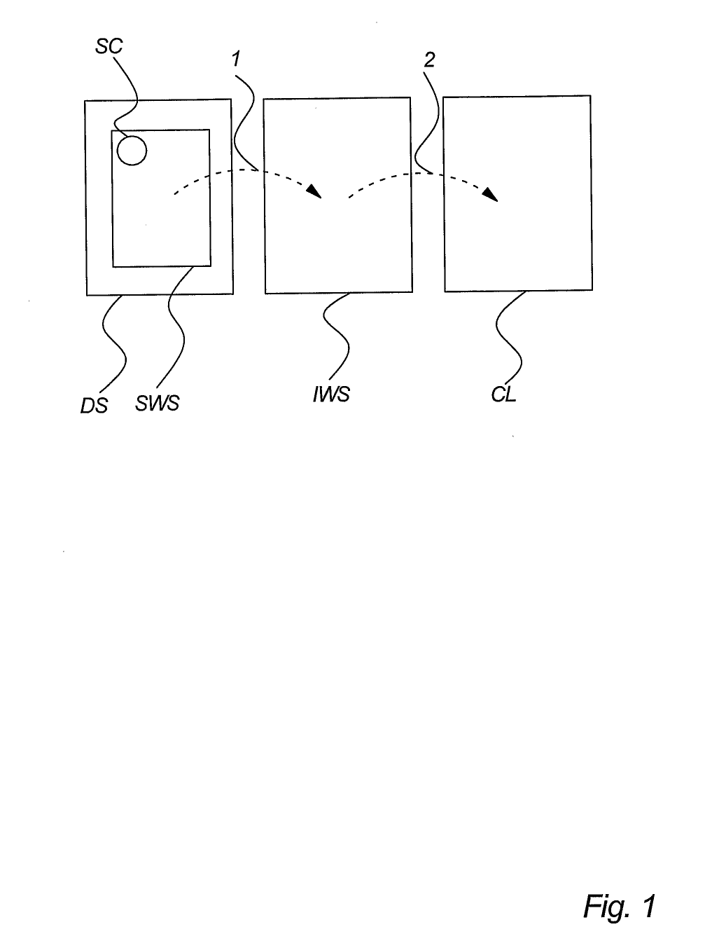

FIG. 1 illustrates an embodiment of the present invention. The system comprises a data source DS, e.g. a web server, associated with a source web site SWS and scripts SC, an intermediate web server IWS and a client CL.

The term web server should be understood in the broadest sense, and may comprise any computer or processor on a network, e.g. a PDCN (PDCN: Public data communication network) that contains data or applications shared by users of the network on clients.

The web server may comprise or communicate with a source web site SWS which may be any web site. A web site is a collection of electronically defined pages generally formatted in a markup language, e.g. HTML (HTML: Hypertext Markup Language), XHTML (XHTML: Extensible hypertext markup language), WML (WML: Wireless markup language), XML (XML: Extensible markup language), etc. that may comprise text, graphic images, and multimedia effects such as sound files, video and/or animation files. Furthermore the source web site SWS may comprise scripts SC written in a script languages such as JavaScript, JScript, VBScript, Flash etc. The system may comprise one or several data sources DS and/or one or several source websites SWS.

The intermediate web server IWS comprises any computer or data processor in a network, e.g. a PDCN (PDCN: Public data communication network). The content of the source web site SWS is at least partly transmitted 1 to an intermediate web server IWS where it is transformed into client suitable data to be visualized on at least one client CL, whereto it subsequently may be transmitted 2. The intermediate web server IWS may in one embodiment of the invention comprise a portal web server, providing services from several source web sites SWS.

The transmissions 1+2 may be established over a data communication network, a public data communication network, e.g. the internet over a communication protocol e.g. the HTTP (HTTP: Hypertext transfer protocol), TCP/IP (TCP/IP: transmission control protocol/internet protocol), UDP (UDP: user datagram protocol), FTP (FTP: file transfer protocol), etc.

The client CL may comprise any computer system that accesses a service on another computer, e.g. a data source DS via an intermediate web server IWS through a network e.g. a PDCN.

It is noted that the source web site SWS may comprise one, two or several data sources and the data sources may comprise separate web-based data sources or e.g. simply data bases communicating directly with the intermediate web server IWS.

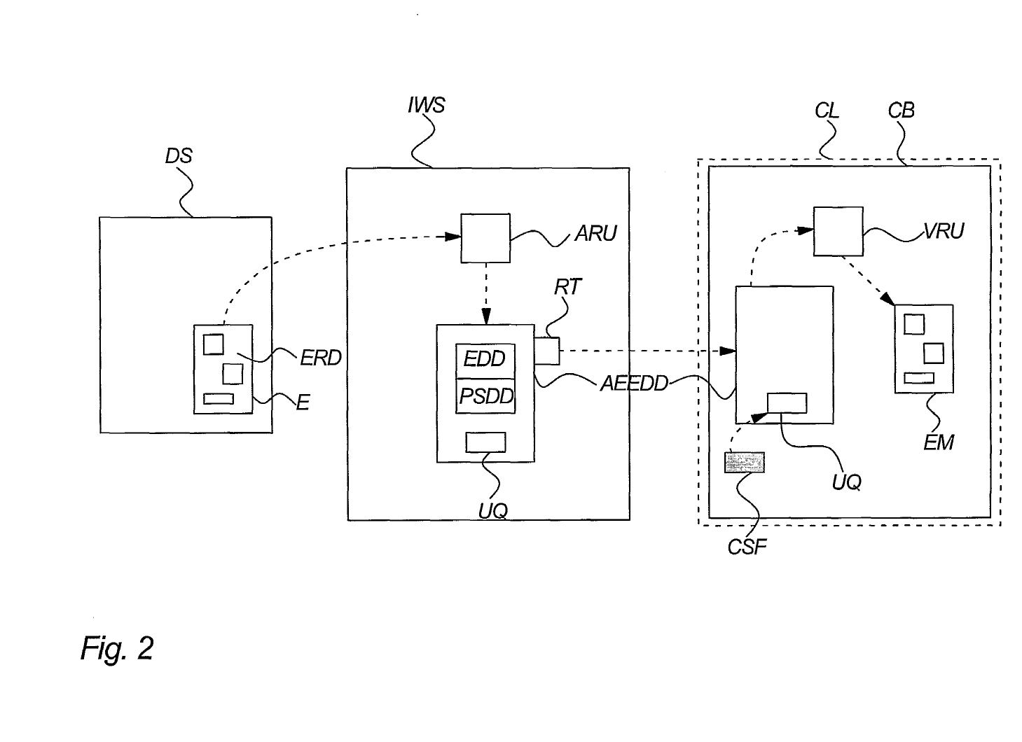

FIG. 2 illustrates a more detailed description of the above-described embodiment of the present invention. The system comprises a data source DS at least partly defining an element E by element representative data ERD. Furthermore the system comprises an intermediate web server IWS, an analytical rendering unit ARU, analytically expressed element defining data AEEDD, element defining data EDD, position and scaling dependent data PSDD, unknown quantities UQ and a rendering transmitter RT. Moreover the system contains a client CL comprising a client browser CB, analytically expressed element defining data AEEDD, unknown quantities UQ, client specific factors CSF, a visual rendering unit VRU and an element match EM.

In a preferred embodiment of the present invention, an element E may comprise a DOM (DOM: Document object model) node which may be a single leaf node, or a tree of nodes with the element as root node. For a tree of nodes, the element is considered to be composed of all the descendant nodes, though references to the element will point to the root node. Thus an element may in the client browser CB be defined by an object in the document object model DOM.

The data source DS may comprise web server pursuant to the above description and may contain an element E defined by element representative data ERD. The element E may be at least a part of the content on a source web site, and may in one embodiment of the invention comprise electronically defined pages generally formatted in a markup language, e.g. HTML (HTML: Hypertext Markup Language), XHTML (XHTML: Extensible hypertext markup language), WML (WML: Wireless markup language), XML (XML: Extensible markup language), etc. that may comprise text, graphic images, and multimedia effects such as sound files, video and/or animation files. Furthermore the source web site SWS may comprise scripts SC written in script languages such as JavaScript, JScript, VBScript, Flash etc. The system may comprise several web servers and several source websites SWS.

Alternately the data source DS may in one embodiment of the present invention comprise a database or any suitable data storage means.

The intermediate web server IWS comprises an analytical rendering unit ARU performing an analytical rendering of element representing data ERD resulting in that element representing data ERD, which may be received from a data source DS, is transformed into analytically expressed element defining data AEEDD. These analytically expressed element defining data AEEDD comprise extracted unknown quantities UQ to be substituted with client specific factors CSF in a deferred computation as regards the visual rendering at the client CL. Furthermore the analytical rendering performed by the analytical rendering unit ARU may comprise computation and/or execution of the non-visual business logic of the element representing data ERD. The element defining data AEEDD may thus comprise any data in any sequence required to establish a complete visual rendering of one or several elements, alone or in conjunction, at the client.

The transformation may thus involve a transformation of one element into several elements, several elements into one element or several elements into another corresponding combination of element(s). The unknown quantities may relate to element (s) on an element by element basis, to a group of relevant elements or any combination thereof.

The unknown quantities UQ may in an embodiment of the invention comprise definitions of sizes and positions, e.g. the position of elements in a browser, font types, font sizes, browser types, window sizes, screen size, screen resolution and other factors that are exclusively accessible in the context wherein they are to be visually rendered, i.e. at the client CL.

Therefore it is within the scope of the invention that all scripting is analytically rendered together with the element representing data ERD, but position calculations which include factors UQ which are inaccessible at the intermediate web server IWS, are extracted and incorporated into the visual rendering in the visual rendering unit VRU at the client CL.

The unknown quantities UQ may in an embodiment of the invention comprise information of how to modify a DOM or e.g. an element in a document object model DOM. Alternately the unknown quantities UQ may comprise properties with reference to a node or object in a document object model DOM.

Furthermore the unknown quantities UQ may comprise position properties with reference to a an existing DOM in a client browser CB

The DOM is in accordance to the present invention to be understood as a description of how an HTML or an XML document is represented in an object-oriented fashion. DOM provides an application programming interface to access and modify the content, structure and style of the document. Through the DOM it is possible for a script language such as JavaScript, JScript, VBScript, Flash etc., to manipulate the existing elements of a visualized element in the client browser CB.

In other words, the invention introduces an analytical rendering in the sense that the resulting rendering is produced on the basis of analytical unknown quantities which are interrelated by analytical expressions which may be resolved at the client, thereby preserving all or at least most mutual relationships between elements or element comprising sub-elements. In this way, a new or modified element may be established and rendered relative to already rendered element at e.g. one client irrespective of the fact that the absolute position is unknown at the intermediate server due to the fact that all or most relevant elements have been positioned with the same types of unknown quantities.

The analytically expressed element defining data AEEDD are transmitted to the client CL via a rendering transmitter RT. At the client CL the analytically expressed element defining data AEEDD are merged with client specific factors CSF and visually rendered by the visual rendering unit VRU. The visual rendering in the visual rendering unit VRU establishes an element match EM.

In an embodiment of the invention the visual rendering in the visual rendering unit VRU comprises an interpretation of the contents of a web document, or other file so that it can be visualized. The visual rendering may be performed by the client browser which may be any web browser, e.g. Microsoft Internet Explorer, Mozilla Firefox, Netscape, etc.

The element match EM is according to the previously described invention, a representative of the element originally defined by the element representative data ERD in the intermediate web server IWS. Thus the element is represented and positioned in a correct manner corresponding to the positioning in the original context in the data source DS.

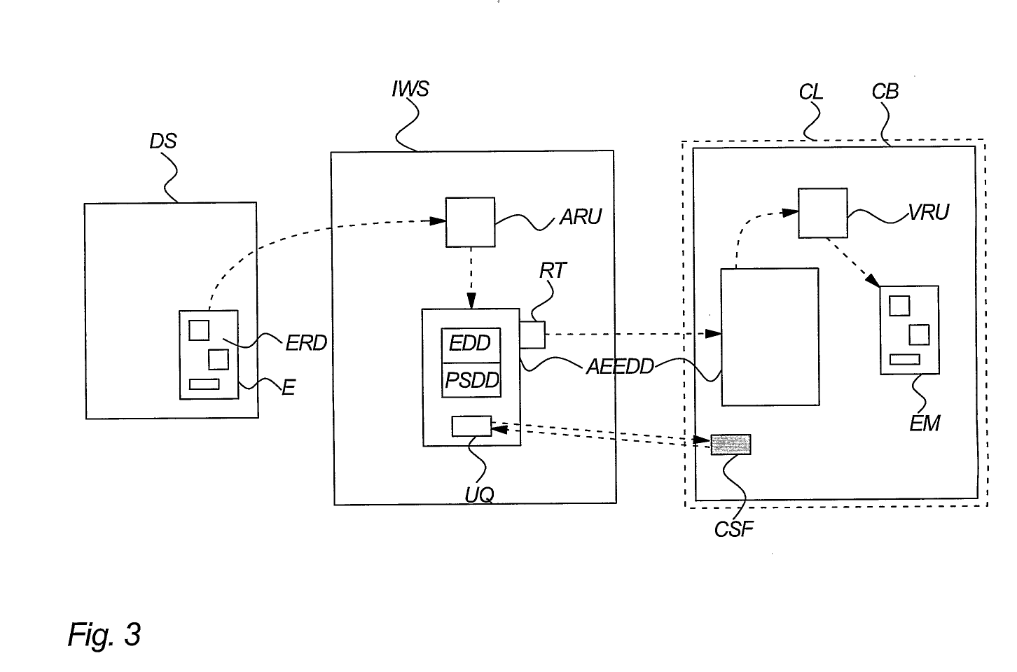

FIG. 3 illustrates a further embodiment of the system. This figure is illustrates a modification of FIG. 2, to visualize another embodiment of the invention.

The analytically rendering, performed by the analytically rendering unit ARU in accordance with the above description performs an inquiry for the client specific factors CSF at the client CL. This way it is possible to determine positioning and create analytically expressed element defining data AEEDD to be transmitted to the client for a visual rendering by the visual rendering unit VRU.

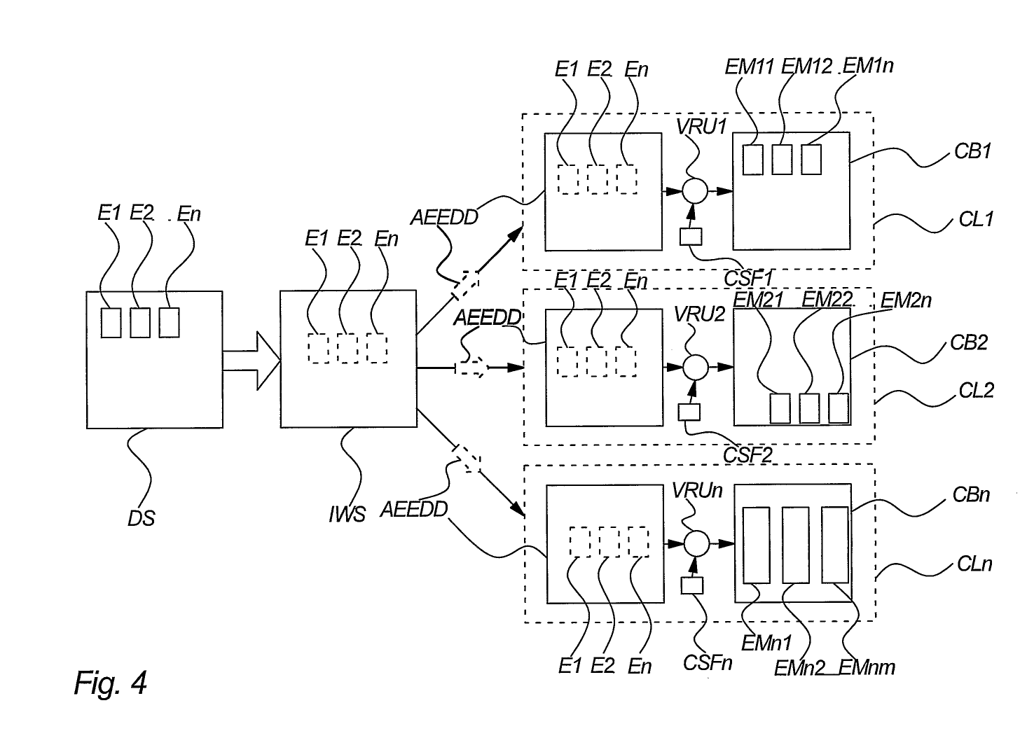

FIG. 4 illustrates an embodiment of the invention. The system comprises a data source DS at least partly defining elements E1, E2, . . . , En,

Furthermore the system comprises an intermediate web server IWS, defining the elements E1, E2, . . . , En, analytically expressed element defining data AEEDD, clients CL1, CL2, . . . , CL3, client browsers CB1, CB2, . . . , CBn, visual rendering units VRU1, VRU2, . . . , VRUn, client specific factors CSF1, CSF2, . . . , CSFn, element matches EM11, EM12, . . . , EM1n, EM21, EM22, . . . , EM2n, EMn1, EMn2, . . . , EMnm. Furthermore the system comprises analytically expressed element defining data AEEDD.

The data source DS comprises in this example three elements on a data source DS. The data source DS may e.g. comprise a web site according to the earlier description with reference in FIGS. 1 and 2. The elements are transmitted to an intermediate web server. The intermediate web server is producing analytically expressed element defining data AEEDD which comprises the element definitions and corresponding positioning information. These analytically expressed element defining data AEEDD are transmitted to the clients which are connected to the given intermediate web server via a network e.g. the public data communication network. It should be noted the analytically expressed element defining data AEEDD transmitted to the clients CL1, CL2, . . . , CL3, may be at least partly and preferably fully identical. The analytically expressed element defining data AEEDD comprising the elements E1, E2, . . . , En to be visually rendered in a visual rendering unit VRU together with client specific factors CSF1, CSF2, . . . , CSFn to establish the element matches EM1, EM2, . . . , EMn in the client browsers. It should be noted that the visualization of the element matches EM1, EM2, EM3 in the client browsers CB1, CB2, CB3 are differing.

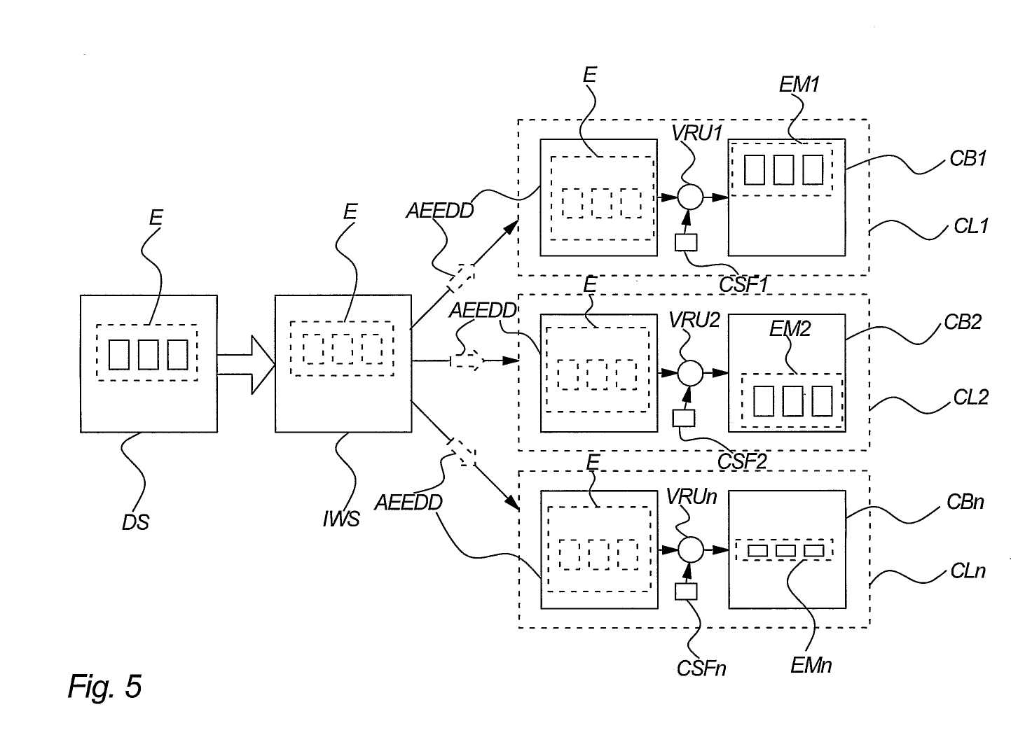

FIG. 5 illustrates an alternative embodiment of the invention.

The present embodiment corresponds structurally to the embodiment of FIG. 4, but in this embodiment the element E is transmitted to the individual clients CL1, CL2 and CLn as a group of elements where the sub-elements are mutually fixed in the sense that e.g. a scaling of the complete element will result in a corresponding modification of all the sub-elements so that interrelations are maintained.

A further example of a detailed embodiment of the invention is illustrated below. The example may e.g. be implemented in a system comprising some principle elements of FIG. 2.

A typical setup in which analytical rendering can be applied comprises a data source DS, e.g. a web server, an intermediate web server IWS, and a client browser CB. The data source DS, e.g. a web server serves a page, which is processed by the intermediate web server IWS. The intermediate web server produces a resulting page which is served to the client and displayed in a client browser CB. The resulting page can be composed of content from multiple data sources which means that the original page cannot simply be send directly to the client.

A preferred approach is to process the original page at the intermediate web server IWS, just as it would have been processed in a usual web browser. However, in some applications, the intermediate web server IWS does not have the required display information and certain computations cannot be completely evaluated. Specifically, the intermediate web server may not directly determine the widths and heights of elements in the page because these are dependant on the visual rendering at the client. The visual rendering, and thus sizes and positions of elements, may depend on the browser type e.g. Internet Explorer or Firefox, the device, e.g. Macintosh, or a mobile phone, window size, and so on.

A specific HTML context where the invention may be utilised is in the following example, which would be difficult to render according to the prior art.

Consider the following HTML page served by the data source DS:

```
<html>
<head>
<script type=“text/javascript”>
  function loaded( ) {
    table2.style.position = “absolute”;
    table2.style.left = (table1.offsetLeft +
        (table1.offsetWidth / 2) −
        (table2.clientWidth / 2)) + “px”;
  }
</script>
</head>
<body onLoad=“loaded( );”>
<center>
  <table id=“table1” bgColor=“#00ff00”>
  <tr><td>Element 1</td></tr></table>
</center>
<table id=“table2”>
<tr>
  <td bgColor=“#ff0088”>Element 2A</td>
  <td bgColor=“#ff8800”>Element 2B</td>
</tr>
</table>
</body>
</html>
```

Here, table2 is positioned relative to table1 by the JavaScript. Visually, table1 is declared by the HTML to be centered, and the script will programmatically center table2 under table1 using the positions and sizes of table1 and table2. Notice, that the HTML does not specify the absolute widths of the tables, so it is completely in the hands of the client browser CB to determine these quantities when laying out the elements.

The analytical rendering at the intermediate web server IWS parses the HTML and evaluates the JavaScript partially or fully. JavaScript expressions containing a reference to a positioning property such as offsetWidth will, instead of being fully evaluated, result in an analytical positioning expression being generated. Thus, the result of the analytical rendering of the above HTML could be a DOM and the following analytical positioning expression of the type element.style.left:

table2.style.left=table1.offsetLeft+table1.offsetWidth/2−table2.clientWidth/2+“px”

Evidently, other expressions comprising other relevant positioning properties may be applied if desired.

Notice, that the other JavaScript expression could be fully evaluated at the intermediate web server IWS, and that the above analytical positioning expression only contains references to unknown positioning properties.

Now, the DOM and the analytical positioning expression are sent to the client browser CB to be visually rendered. This rendering can be done precisely because the client browser CB has access to the previously unknown positioning information—in this case, offsetLeft, and offsetWidth of the tables in question.

In the following a number of preferred script references to unknown quantities which may generally be applied according to an embodiment of the invention are listed. In the present context the unknown positioning quantities may relate to e.g. element, screen or window.

### Elements:

Applicable positioning elements are scrollHeight, element.scrollLeft, element.scrollTop, element.scrollWidth, element.clientLeft, element.clientTop, element.clientWidth, element.clientHeight, element.offsetLeft, element.offsetTop, element.offsetWidth, element.offsetHeight,

element.style.font, element.style.background, element.style.clip, element.style.height, element.style.width, element.style.border, element.style.margin, element.style.top, element.style.pixelHeight, element.style.pixelLeft, element.style.pixelTop, element.style.pixelWidth, element.style.left, element.style.cssText, element.style.fontSize, element.style.backgroundPosition, element.style.backgroundPositionX, element.style.backgroundPositionY, element.style.borderBottom, element.style.borderBottomWidth, element.style.borderLeft, element.style.borderLeftWidth, element.style.borderRight, element.style.borderRightWidth, element.style.borderTop, element.style.borderTopWidth, element.style.borderWidth, element.style.bottom, element.style.layoutGrid, element.style.layoutGridLine, element.style.layoutGridChar, element.style.letterSpacing, element.style.lineHeight, element.style.marginBottom, element.style.marginLeft, element.style.marginRight, element.style.marginTop, element.style.minHeight, element.style.padding, element.style.paddingBottom, element.style.paddingLeft, element.style.paddingRight, element.style.paddingTop, element.style.posBottom, element.style.posHeight, element.style.posLeft, element.style.posRight, element.style.posTop, element.style.right, element.style.pixelBottom, element.style.pixelRight, element.style.textIndent, element.style.wordSpacing, element.style.zIndex, element.style.zoom

So-called analytically expressed element defining data is generally referred to as data which may affect the rendering of one or several elements of a web-site. Thus, further examples of such data may be screen and window data. Evidently several other corresponding properties or attributes may be relevant and applied within the scope of the invention as long as they may be applied for positioning of elements at a window of a client. Thus, applicable properties within the scope of the invention may be named different as long as the functioning is the same or at least corresponding.

Relevant screen data which may also be associated to the rendering of an element comprises screen.availHeight, screen.availWidth, screen.height, screen.width, screen.deviceXDPI, screen.deviceYDPI, screen.logicalXDPI, screen.logicalYDPI.

Relevant window data which may also be associated to the rendering of an element comprises window.dialogHeight, window.dialogLeft, window.dialogTop, window.dialogwidth, window.screenLeft, window.screenTop.

According to the invention, the abovementioned screen data and window data are also comprised in the definition of unknown quantities UQ.

Analytical Rendering The process of partially evaluating a script with the goal of evaluating as many expressions as possible not related to positioning, and building a set of remaining positioning expressions. The remaining positioning expressions cannot be further evaluating without obtaining certain unknown quantities UQ which are only known at the client.

Visual Rendering The process of obtaining all previously unknown quantities in a set of positioning expressions, so that all expressions can be evaluated to atomic values. These atomic values are then assigned to positioning properties on elements.

1.-45. (canceled)

46. Method of rendering at least one element in a client browser at a client, wherein said element is defined at an intermediate web server by element representative data and where said element is obtained from at least one data source, said method comprising:
performing an analytical rendering comprising a transformation of said element representative data into analytically expressed element defining data comprising unknown quantities, and
performing a visual rendering wherein said unknown quantities are substituted with client specific factors.

47. Method of rendering at least one element E in a client browser at a client according to claim 46, wherein said element is defined at an intermediate web server by element representative data and where said element is obtained from at least one data source, said method further comprising:
performing an analytical rendering comprising a transformation of the content in said element representative data into analytically expressed element defining data comprising unknown quantities, and
transmitting said analytically expressed element defining data to the client browser, performing a visual rendering on the basis of said analytically expressed element defining data, wherein said unknown quantities are substituted with client specific factors obtainable in the present context.

48. Method of rendering at least one element according to any of the claim 46, wherein said element is defined in a Document Object Model.

49. Method of rendering at least one element according to any of the claim 46, wherein said analytical rendering is performed on said intermediate web server.

50. Method of rendering at least one element according to any of the claim 46, wherein said analytical rendering comprises a transformation of existing positioning values into relative positioning values with respect to a Document Object Model.

51. Method of rendering at least one element according to any of the claim 46, wherein said analytically expressed element representing data comprise data coded in at least one markup language.

52. Method of rendering at least one element according to any of the claim 46, wherein said analytically expressed element representing data comprise definitions in scripting languages, comprising JavaScript, Jscript, Flash, VBScript, etc.

53. Method of rendering at least one element according to any of the claim 46, wherein said unknown quantities comprise definitions of sizes and positions, comprising position of existing elements at a client, font types, font sizes, browser types, window sizes, screen size, screen resolution, etc. defined as corresponding exact values at said client.

54. Method of rendering at least one element according to any of the claim 46, wherein said unknown quantities comprise position properties with reference to a Document Object Model comprising “element.X”.

55. Method of rendering at least one element according to any of the claim 46, wherein said client specific factors comprise factors dependent on the positioning of other elements at the client.

56. Method of rendering at least one element according to any of the claim 46, wherein said intermediate web server comprises a computer communicating with said client over the internet protocol.

57. Method of rendering at least one element according to any of the claim 46, wherein said intermediate web server comprises a web clipping server.

58. Method of rendering at least one element according to any of the claim 46, wherein said client is a device communicating with said intermediate web server via the Internet Protocol via port 80 or 443.

59. Rendering intermediate web server for rendering at least one element, wherein said element is defined at the intermediate web server by analytically expressed element representative data and wherein said element is obtained from a data source, said rendering server comprising
an analytically rendering unit, performing an analytical rendering involving a transformation of the content in said element representative data into analytically expressed element representative data comprising analytically expressed unknown quantities, and
a rendering transmitter, transmitting said transformed element representative data to a client.

60. Method of rendering according to claim 46, wherein said rendering is configured for representation of a visual element retrieved from a data source for establishment of a visual rendering at a client.
